(19) United States
(12) Patent Application Publication
(10) Pub. No.: US 2016/0350768 A1
(43) Pub. Date: Dec. 1, 2016

(54) COMPUTERIZED SYSTEMS AND METHODS FOR SALES AND MARKETING PROCESS MANAGEMENT

(71) Applicant: 100INSIGHTS, Inc., West Des Moines, IA (US)

(72) Inventor: Matthew T. Ostanik, Dallas Center, IA (US)

(21) Appl. No.: 15/052,541

(22) Filed: Feb. 24, 2016

Related U.S. Application Data
(63) Continuation of application No. PCT/US15/33490, filed on Jun. 1, 2015.

(51) Int. Cl. G06Q 30/02

(52) U.S. Cl. CPC G06Q 30/0201

(57) ABSTRACT

A system and method are provided which allow a user to define a computerized sales and marketing process management system. The system includes a plurality of user-defined stages and identifies retrieved sales and marketing electronic records as belonging to one or more stages by using a set of user-predefined parameters for inclusion of an electronic record in each stage. The system allows a user such as a supervisor to define stage record or activity goals and goal conversion ratios between each stage and provides automated alert feedback to a user such as a salesperson when a goal is not met. A goal determination system allows a supervisor to build individual and sales teams goals dynamically from a starting number of leads or a desired total revenue starting point. Marketing or sales activity goals may also be established and tracked based on a wide variety of user-defined parameters.

The present application is a continuation of International Application No. PCT/US2015/033490 with an international filing date of Jun. 1, 2015, entitled “COMPUTERIZED SYSTEMS AND METHODS FOR SALES AND MARKETING PROCESS MANAGEMENT,” which is hereby incorporated by reference in its entirety.

### BACKGROUND OF THE INVENTION

The present invention generally relates to systems and methods for electronic sales and marketing process management.

Sales and marketing are a necessary element of all commercial enterprises and managing sales and marketing processes is a multi-billion dollar business. Several systems for sales and marketing management have been produced or are available. One of the most popular types of systems are Customer Relationship Management (CRM) systems such as Salesforce.com. CRM systems attempt to manage a company's interactions with current and future customers and typically use software to organize at least one of sales, marketing, customer service, or technical support.

However, while CRM software may provide a useful front end for entry of sales or marketing data, CRM software does not provide detailed analysis and sales metric tracking. Consequently, a CRM user or their supervisor or manager often is forced to make broad estimations as to sales and marketing process performance instead of having accessible and usable sales and marketing process performance metrics.

### BRIEF SUMMARY OF THE INVENTION

One or more of the embodiments of the present invention provide a computerized sales and marketing process management system which allows a user to pre-configure a plurality of user-defined stages. The user additionally establishes a set of parameters for each stage for use in determining whether a retrieved sales or marketing electronic record is to be included in any of the stages. A supervisor may define stage record or activity goals and goal conversion ratios between each stage and the system provides automated alert feedback to a user such as a salesperson when a stage record or activity goal is not met. Additionally, a supervisor may use a goal determination system allows to build individual and sales teams goals dynamically from a starting number of leads or a desired total revenue starting point. Further, marketing or sales activity goals may be established and tracked on a wide variety of user-defined parameters, such as whether an electronic record constitutes sales or marketing activity and the lead source of the electronic record.

### BRIEF DESCRIPTION OF THE DRAWINGS

FIG. 1 illustrates a computerized sales and marketing process management system, according to an embodiment of the present invention.

FIG. 2 illustrates an embodiment of the MSASDS sales and marketing activity display interface.

FIG. 3 illustrates an embodiment of a multi-time period MSASDS sales and marketing activity display interface.

FIG. 4 illustrates an embodiment of a multi-activity MSASDS sales and marketing activity display interface with a view of revenue funnels for different lead sources compared to each other.

FIG. 5 illustrates an embodiment of the MSASDS sales and marketing activity and goal tracking interface.

FIG. 6 illustrates an embodiment of a MSASDS sales and marketing activity goal determination interface.

FIG. 7 illustrates one embodiment of the goal determination interface 600 wherein a supervisor builds backwards from a desired total revenue to set goals.

FIG. 8 illustrates another embodiment of the goal determination interface wherein a supervisor builds forward from a desired number of leads to set goals.

FIG. 9 illustrates a conversion percentage adjustment interface.

FIG. 10 illustrates an embodiment of a lead source activity goal determination interface.

FIG. 11 illustrates a sample supervisor or control screen for configuring and the activity display interfaces shown in FIGS. 1-10.

### DETAILED DESCRIPTION OF THE INVENTION

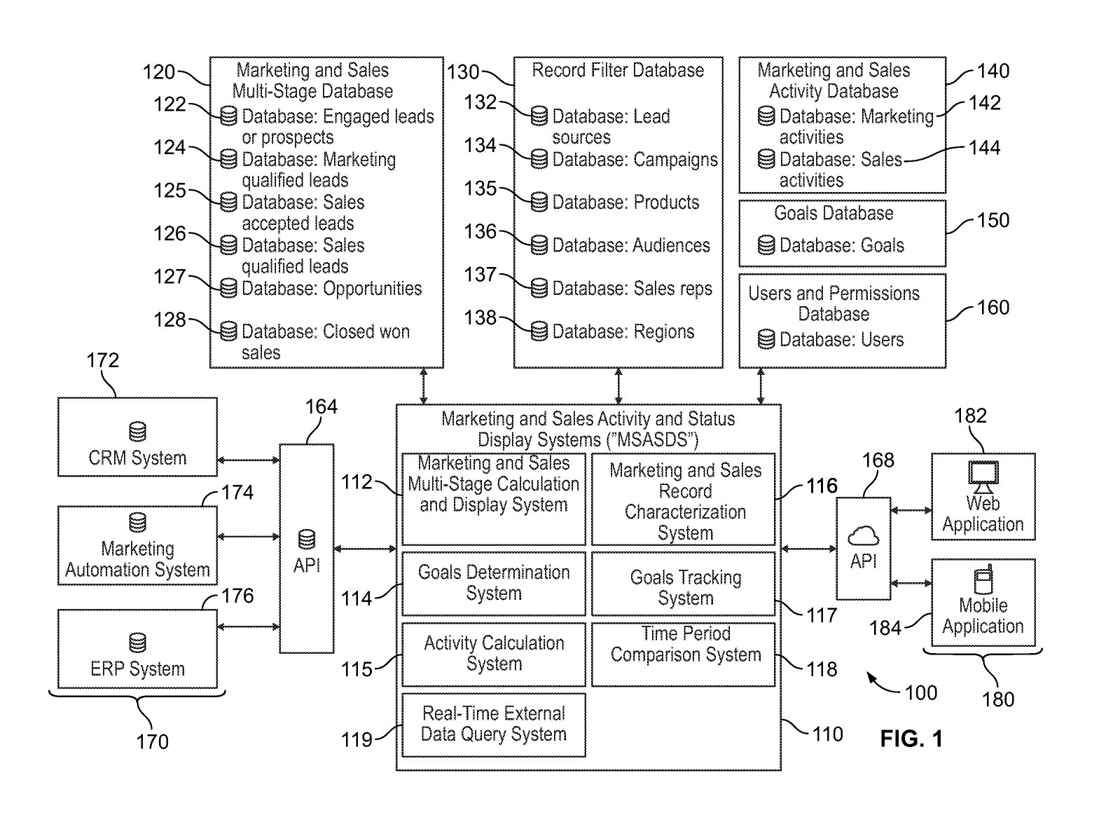

FIG. 1 illustrates a computerized sales and marketing process management system 100, according to an embodiment of the present invention. The computerized management system 100 includes a Marketing and Sales Activity and Status Display System (hereinafter “MSASDS”) 110, marketing and sales multi-storage databases 120, record filter databases 130, marketing and sales activity databases 140, goals database 150, and users and permissions database 160. Additionally, external data tracking, recordation, and/or retention systems 170 may include one or more Customer Relationship Management (CRM) systems 172, one or more marketing automation systems 174, and one or more Enterprise Resource Planning (ERP) systems 176. Additionally, user access systems 180 are shown that may include a web application 182 and a mobile application 184.

The external data tracking, recordation, and/or retention systems 170 communicate with the MSASDS through the legacy system Application Programming Interface (API) 164. The user access systems 180 communicate with the MSASDS through the user access Application Programming Interface (API) 168.

The MSASDS 110 includes the Marketing and Sales Multi-Stage Calculation and Display System 112, the Goals Determination System 114, the Activity Calculation System 115, the Marketing and Sales Record Characterization System 116, the Goals Tracking System 117, the Time Period Comparison System 118, and the External Data Query System 119.

The marketing and sales multi-storage databases 120 includes a engaged leads or prospects database 122, a marketing qualified leads database 124, a sales accepted leads database 125, a sales qualified leads database 126, a opportunities database 127, and a closed won sales database 128.

The record filter database 130 includes a lead sources database 132, a campaigns database 134, a products database 135, an audiences database 136, a sales rep database 137, and a regions database 138.

The marketing and sales activity database 140 includes the marketing activities database 142 and the sales activities database 144.

In operation, a user desiring to establish a sales and marketing management process on the computerized MSASDS logs into the MSASDS and begins configuration of the process as further described below. First, the user establishes the desired number of marketing and/or sales stages in the management process and names the stages, which are then stored. For each stage, electronic marketing and sales records may be retrieved from the external system 170 and/or from the marketing and sales multi-storage databases 120. Each electronic marketing and sales record includes a plurality of electronic marketing and sales record parameters. The user may select whether an electronic marketing and sales record is included in one or more sales or marketing stages by associating each sales and/or marketing stage with a predetermined set of electronic marketing and sales record parameters, that associated parameters are then stored with an identifier of their respective stages.

Thus, when an electronic marketing and sales record is retrieved, the MSASDS analyzes the electronic customer record's parameters and compares the parameters to the parameter set for each stage of the management process. When the record parameters match the stage's parameter set, then the electronic marketing and sales record is included as part of the stage.

Each stage of the management process may then be populated and displayed to the user along with all current actual closed sales activity and revenue. Additionally, tracking of sales and/or management activity and comparison with previous performance may be displayed, including performance for a specific product and/or specific salesperson.

Additionally, as further described below, the MSASDS may be used to establish goals for multiple stages in a sales and/or marketing process. For example, goals may be established by either working forward from a target number of leads at the stop stage of the user's sales and/or marketing process or by working backward from a desired revenue target. For example, historical information with regard to the percentage of sales opportunities that are converted into sales by a specific team and/or sales person may be used to determine the number of sales opportunities that are projected to be desirable to meet a predetermined revenue goal. In one embodiment, each of the stages of the marketing and/or sales process may be revised in real time and may include alerts when projections indicate additional actions are desirable to meet predetermined goals.

Returning to FIG. 1, in FIG. 1, the user has decided to implement a sales and/or marketing process including the following stages: 1) Engaged Leads or Prospects, 2) Marketing Qualified Leads (MQLs), 3) Sales Accepted Leads, 4) Sales Qualified Leads (SQLs), 5) Opportunities, and 6) Closed Won Sales. For each of the predetermined stages, the user selects the electronic record parameter set that will cause a marketing and sales electronic record to be included in the stage.

The specific parameters used to include a record in a stage vary based on the type of record and the external system 170 that the record is being retrieved form and may be established by the user when setting up the MSASDS system or modified at a later time. In one example, a record of an individual person or lead may be retrieved from a CRM system 172 or a marketing automation system 174. The parameters used to determine if the record should be included in a stage may include a record status field in the CRM system, a numeric score or “lead score” in the CRM system, and the values of fields such as the individual's name, title, email address, phone number, and/or mailing address. In another example, a record of a sales opportunity may be retrieved from a CRM system 172. The parameters used to determine if the record should be included in a stage may include the opportunity status field in the CRM system, the value of the opportunity, or other fields associated with the opportunity in the CRM system.

The MSASDS then retrieves electronic customer records from an external system such as the CRM system 172. Specifically, the CRM system includes a mode that is responsive to external commands from external systems transmitted via the API 164. The MSASDS sends an electronic command through the API requesting a set of electronic marketing and sales records, including specifying what information about each record is to be received. The CRM then transmits the requested records to the MSASDS through the API. As each electronic marketing and sales record is received by the MSASDS, it is passed to the Marketing and Sales Record Characterization System 116. At the Marketing and Sales Record Characterization System 116, the parameters of the electronic customer record are first compared with the set of parameters that has been selected by the user to cause the electronic marketing and sales record to be included in the Engaged Leads or Prospects stage. When the electronic record parameters match the predetermined set of parameters for inclusion in the Engaged Leads or Prospects stage, the record is stored in the engaged leads or prospects database 122.

Next, the Marketing and Sales Record Characterization System 116 compares the electronic record parameters with the set of parameters for inclusion in each of the Marketing Qualified Leads (MQLs) stage, Sales Accepted Leads stage, Sales Qualified Leads (SQLs) stage, Opportunities stage, and Closed Won Sales stage. When the parameters of the electronic record match the set of parameters for inclusion in any stage, the electronic record is stored in the database 124-128 associated with the stage.

One example of this selection process by the Marketing and Sales Record Characterization System is when the user has set the system to only consider a lead to part of the Engaged Leads or Prospects stage if the lead record has a lead score of 10 or greater. In this example, the lead record in the CRM has a field associated with it that contains a numeric value, the lead score, where the value may range from 10 to 1000, and the number is increased based on the lead's interactions with the company's marketing activities. In this example, a lead score of 10 may indicate that the lead has had at least 10 interactions with the company's marketing activities, where such interactions may include opening marketing emails or visiting pages on the company's website. In this example, the Marketing and Sales Record Characterization System evaluates each lead record as it is received through the API from the CRM and looks at the value of the lead score field on the record. If the value of the lead score is 10 or greater, the Marketing and Sales Record Characterization System saves the record in the Engaged Leads or Prospects database 122. If the value of the lead score is less than 10, the Marketing and Sales Record Characterization System does not save the record. The Marketing and Sales Record Characterization System then moves on to the next record that is transmitted from the CRM. Similarly, the electronic record includes a lead score of 50, the record is included in the MQL database. A score of 100 is required for placement in the SQL database, a score of 500 for the Opportunities database, and only electronic records including an entry establishing that a sale has been made are included in the Closed Won database. Additionally, in other embodiments, the specific lead scores associated with inclusion in the respective databases may be set by users implementing the MSASDS in accordance with company preferences and policies. Another example of a selection process by the Marketing and Sales Record Characterization System would be if the user has set the system to only consider a lead to be part of the Engaged Leads or Prospects stage if the lead has a lead status equal to Engaged. In this example, the lead record in the CRM has a status field associated with it with a text value. The CRM transmits the record to the MSASDS through the API. The MSASDS sends the record to the Marketing and Sales Record Characterization System which then looks at the value of the lead status on the record. If the value of the lead status field equals Engaged, then the Marketing and Sales Record Characterization System saves the record in the Engaged Leads or Prospects database. If the value does not equal Engaged, the system does not save the record. Similarly, electronic records are included in the MQL database, when the electronic record has a status field indicator of MQL, in the SQL database when the electronic record has a status field indicator of SQL, in the Opportunities database when the electronic record has a status field indicator of Opportunities, and in the Closed Won database when the electronic record has a status field indicator of Closed Won.

Another example of a selection process by the Marketing and Sales Record Characterization System would be if the user has set the system to only consider a lead to be part of the Marketing Qualified Leads stage if the lead a status equal to MQL, a lead score of 30 or greater, and an email address that is not null or blank. Similar to the previous example, the MSASDS receives the record from the CRM through the API. The Marketing and Sales Record Characterization System then evaluates the record. If the record's lead status field is set to MQL, and the lead score field has a value of 55, and the email address field has an email address of sampleuser@gmail.com, the system saves the record in the Marketing Qualified Leads database. But in a related example, if the value of the lead status field is set to MQL and the lead score field has a value of 55 but the email address is blank (no email address is saved with the record), then the record would not meet the parameters for this stage and the system would not save the record.

Then, the user may establish electronic record parameter sets that will cause an electronic marketing and sales record to be included as one or more of: 1) a Lead Source, 2) relating to a specific campaign, 3) relating to a specific product or products, 4) relating to a specific audience or market segment, 5) relating to one or more specific sales reps, and/or 6) relating to one or more specific regions. The parameters are mapped to specific fields and values on the electronic marketing and sales records. For example, the Lead Source or campaign may be mapped to the values of a lead source or campaign field or attribute on the record in the CRM system 172 or the marketing automation system 174. In another example, the regions may be determined based on the values of record fields such as the mailing address, state/province, zip code, or phone number.

In one embodiment, an electronic record such as a lead record may include at least the following fields: First name, Last name, Title, Email address, Phone, Company, Lead status, Lead score, Street address, City, State, Zip code, Country, and Lead owner. In one embodiment, any of the Lead status, Lead score, and Lead Owner fields, either alone or in combination, may be set by a user to be analyzed by the system to include the electronic record in one or more of the above-identified databases.

In another embodiment, an electronic record such as an Opportunity record may include at least the following fields: Opportunity name, Company name, Opportunity owner, Close date, Stage, Probability, Dollar amount, and Primary contact. In one embodiment any of the Close date, Stage, Probability, Dollar amount, and Primary contact fields, either alone or in combination, may be set by a user to be analyzed by the system to include the electronic record in one or more of the above-identified databases.

Each of the electronic marketing and sales record's parameters may then be compared by the Marketing and Sales Record Characterization System 116 with the parameter sets for Lead Source. Electronic records having parameters that match the predetermined parameter set for Lead Source may then be stored in the Lead Sources database 132. Further, electronic records having parameters that match the predetermined parameter set for a specific Campaign may then be stored in the Campaigns database 134 associated with that campaign. Similarly, electronic records having record parameters matching the predetermined parameter sets for a specific product, specific audience, specific sales rep, and specific region may be stored in their respective databases 136-138. To do this, the records are transmitted from the CRM through the API. The Marketing and Sales Characterization System compares each record with the criteria. If the criteria are met, the record is saved in the appropriate database as described above. If the criteria are not met, the record is not saved in the database, similar to the characterization process for determining if a record belongs in a specific stage.

More specifically, although an electronic marketing and sales record may typically be associated with only a single stage and thus may typically appear in only one of the marketing and sales databases 122-128, the electronic record may be associated with several of the record filter databases 130. For example, a single electronic marketing and sales record may be associated with a specific sales rep, a specific region, and a specific product, and thus may appear in all three databases. In another example, a single marketing and sales record may be associated with multiple campaigns and thus may appear associated with multiple campaigns in the campaign database in addition to appearing in the sales rep, region, and product databases.

In addition to the examples previously described, another type of record that may be retrieved from a CRM system 172 or a marketing automation system 174 is a record of an open or completed activity. For example, an activity may be an email sent by marketing to a prospect or lead, a phone call by a sales representative, or a meeting between a sales representative and a prospect or lead. The user may establish electronic record parameter sets similar as described above that will cause a marketing and sales activity record to be included as either 1) a Marketing Activity or 2) a Sales Activity. Each of the electronic customer record's parameters may then be compared by the Marketing and Sales Record Characterization System 116 with the parameter sets for Marketing Activity and Sales Activity. Electronic records having parameters that match the predetermined parameter set for Marketing Activity may then be stored in the marketing activities database 142. Further, electronic customer records having parameters that match the predetermined parameter set for Sales Activity may then be stored in the sales activities database 144. Examples of parameters used for this evaluation may include the individual or system that initiated the activity, such as if it was initiated by the marketing automation system in the form of an email to a prospect or lead (which may indicate a marketing activity), or if it was initiated by a sales rep in the form of a phone call to a prospect or lead (which may indicate a sales activity). Other parameters that may be used include the description of the activity or a status field on the activity in the CRM system or marketing automation system. For example, when the activity is described as one or more of the following, then it may be classified as a marketing activity or used in the determination of whether the record is to be included as a marketing activity: Drip Email, Nurture Email, Website Visit, Website Download, Whitepaper Request, Viewed Video, Filled Out Form, and Form Submission. Conversely, when the activity is described as one or more of the following, then it may be classified as a sales activity or used in the determination of whether the record is to be included as a sales activity: Phone Call, Outbound Call, Inbound Call, Conversation, Left Voicemail, LVM, Called No Answer, Called Did Not Leave Message, Called DNLM, Spoke to Gatekeeper, Proposal Sent, Demo Scheduled, Demo Completed, Pricing Sent, Qualification Call, Information Gathering Call, Introduction Call, and Spoke to Decision Maker.

As further described below, a user may then use the MSASDS to display an interface including a count of the electronic records associated with each stage, a comparison with a previous time period, and a count of sales and/or marketing activities associated with each stage.

Additionally, although the example above illustrates a system having six specific marketing and sales multi-storage databases 120, the number of databases is set by the user during setup of the MSASDS when the user specifies the number of stages to be included. In alternative examples, the user may establish a greater or lesser number of stages than the six shown in the example above, which results in a greater or lesser number of databases. Additionally, the databases may be titled differently by the user and may include different records because the factors used to determine what records to be included in a specific database is established by the user when setting up the MSASDS.

In one embodiment, the MSASDS may be a web-based solution, available through standard web browsers over the Internet. The MSASDS may also include applications built for mobile devices such as smartphones and tablets and the mobile apps interact with the main website. The MSASDS may include a secure login function that restricts access to users with permissions. In one embodiment, the MSASDS may be run in a single, multi-tenancy instance and users may only be able to access data and settings for their own company due to security controls within the software. Additionally, the MSASDS may import marketing and sales activity data from the user's customer relationship management (CRM) system and from other external software systems. Integration may be provided for major commercial CRM applications and for other software applications, including but not limited to ERP systems and marketing automation software. In one embodiment, the MSASDS may authenticate user login credentials against their credentials on the CRM application or other system, allowing the user to bypass the login screen and be logged in automatically.

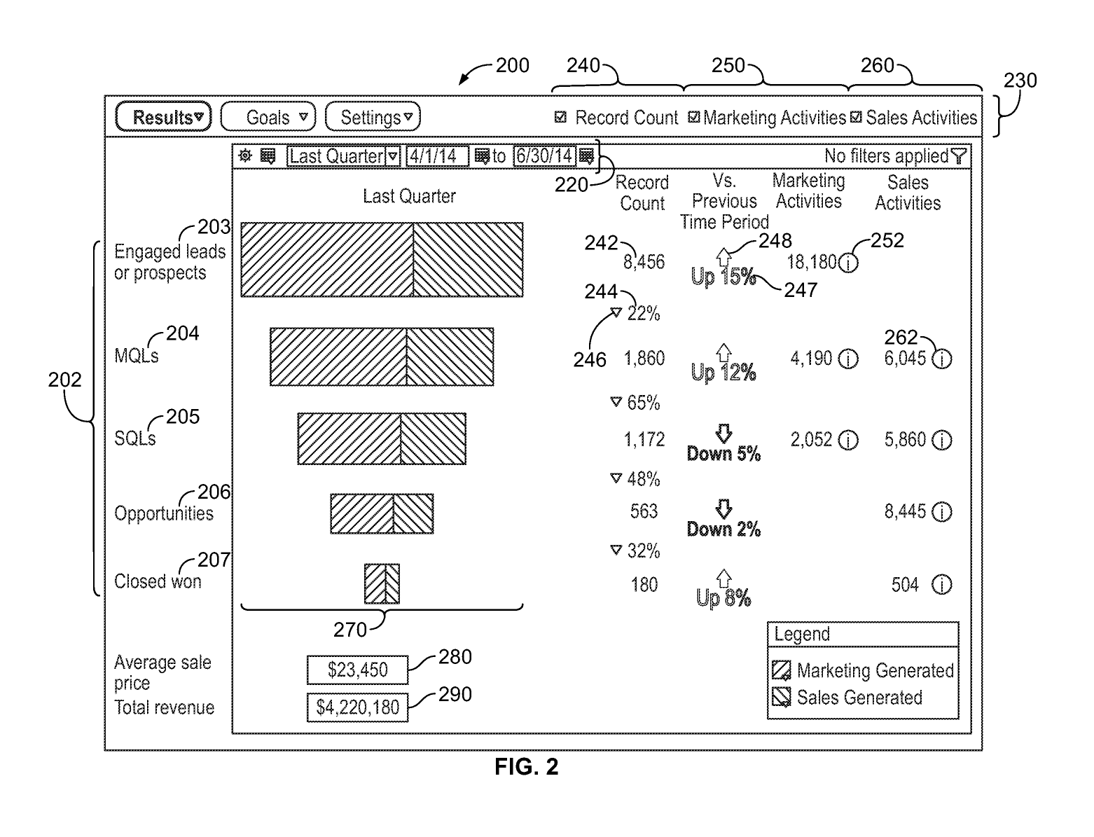

FIG. 2 illustrates an embodiment of the MSASDS sales and marketing activity display interface 200. The display interface 200 includes a set of user-selected stages 202 for display including an Engaged Leads or Prospects stage 203, Marketing Qualified Leads (MQLs) stage 204, Sales Qualified Leads (SQLs) stage 205, Opportunities stage 206, and Closed Won Sales stage 207. The display interface 200 also includes a time period selector 220, and a display information configuration section 230. The display information configuration section 230 allows the user to select and deselect for display the Record Count columns 240, the Marketing Activities Column 250, and/or the Sales Activities Column 260.

In operation, the user selects a subset of the previously determined stages for inclusion in the display interface 200. In the present display interface 200, the user has selected all of the previously determined stages except for the Sales Accepted Leads Stage.

The user also selects a time period for display. In one embodiment, only database entries that meet the required parameters during the selected time period are displayed.

The MSASDS received the selected stages and time period and retrieves from each of the databases associated with the selected stages the electronic marketing and sales records that meet the required parameters in the selected time period. The MSASDS then performs the following.

First, when the record count is selected in the display information configuration section 230 the MSASDS sums and displays the count 242 of the total number of electronic marketing and sales records that are included in each of the stages as shown in the record count columns 240. Additionally, the MSASDS determines the percentage difference 244 in the record count between stages and displays the percentage difference between the stages.

Additionally, for the selected time period, the MSASDS determines the previous time period. The previous time period may be configurable based on the selected time period or may be predetermined. In one example, when the user selected a time period of a quarter, the previous time period may be the previous quarter. In another example, when the user selected a time of a quarter, the previous time period may be the same quarter in the previous year. Alternatively, when the user selects a month, the previous time period may also be a month. In the current embodiment, the user has selected a quarter as the time period and the MSASDS has determined the previous time period to be the previous quarter.

Similarly to the action described above for the current quarter, the MSASDS then proceeds to sums the total number of electronic marketing and sales records that are included in each of the stages for the previous time period. The MSASDS then compares the total number of electronic marketing and sales records in each of the stages in the current time period with the total number of electronic marketing and sales records in each of the stages in the previous time period and displays a change percentage 247 indicating whether the total number of electronic records in the current stage has increased or decreased compared with the previous time period. The MSASDS also displays a change indictor 248 that indicates whether the number has increased or decreased compared to the previous time period.

Next, when the Marketing Activities is selected in the display information configuration section 230 the Marketing Activities column 250 is calculated and displayed. In the Marketing Activities column 250, for each stage the number of marketing activities included in the electronic marketing and sales records for that stage are retrieved from the marketing activities database, summed, and displayed. Not all stages may include records that include marketing activities. Thus, when no marketing activities are included in the electronic records included in the stage, the Marketing Activities column may simply be blank for that stage.

Similarly, when the Sales Activities is selected in the display information configuration section 230 the Sales Activities column 260 is calculated and displayed. In the Sales Activities column 250, for each stage the number of sales activities included in the electronic marketing and sales records for that stage are retrieved from the sales activities database, summed, and displayed. Similarly to the marketing activities above, not all stages may include records that include sales activities. Thus, when no sales activities are included in the electronic marketing and sales records included in the stage, the Sales Activities column may simply be blank for that stage.

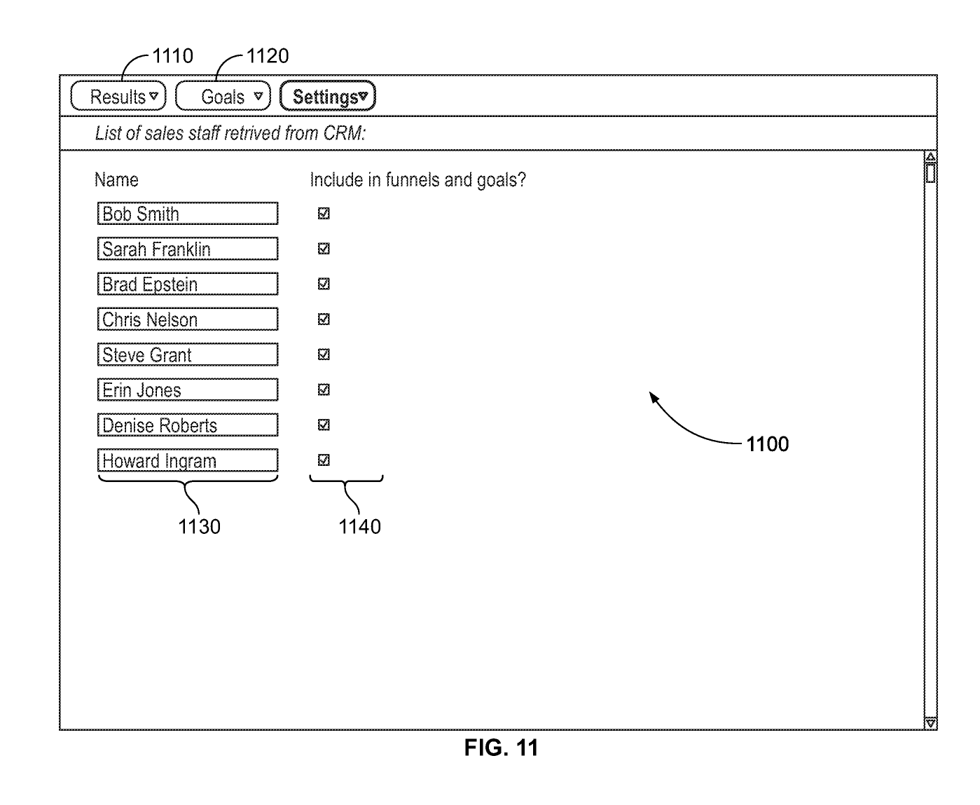

For entries in both the Marketing Activities column 250 and the Sales Activities column 260, a detail information selection preferably appears to the right of the entry. Selection of either the marketing activity entry selector 252 or the sales activity selector 262 causes the MSASDS to display a detailed information screen for the current entry. One embodiment of the detailed information screen is shown below as FIG. 11.

Additionally, as shown in FIG. 2, the total number of marketing and sales records from the count for that stage is displayed as a bar graph 270. The bar graph 270 is preferably normalized with the total number of marketing and sales activities in the first stage occupying the greatest width. For the second stage, the total number of marketing and sales activities in the second stage is compared to the number for the first stage and the bar graph entry for the second stage is scaled in size relative to that of the first stage in proportion to the difference between the number of activities included in the first stage as opposed to the second stage. The process proceeds for each of the successive stages in the display interface 200. The relative scaling for each stage may be constrained by parameters to ensure that the appearance of the stages remains visually readable. For example, if one stage has 100,000 records and the next stage has 1,000 records, the bar graph entries may not be displayed in exact proportion with the first stage being 100 times wider than the next stage. Instead, the system may display the first stage at a width of 10 and the next stage at a width 1, thereby altering the bar graph width to optimize the visual presentation of the stages. The parameters used for this optimization may be calculated based on the user's screen width and device type.

Additionally, each bar in the bar graph preferably includes a first color-coded width representing the number of marketing generated records in the stage and a second color-coded width representing the number of sales generated records in the stage. Further, because the successive bars of the bar graph typically (although not necessarily) decrease in width as they progress, the bars appear to form the shape of a funnel. Consequently, the bar graph may be referred to as a marketing and/or sales funnel.

Additionally, for each electronic marketing and sales record that is included in the closed won sales stage 207, the MSASDS extracts the sales price for the record. The MSASDS then sums the total of all sales and displays it as the total revenue 290. Additionally, the total revenue 290 is divided by the number of records in the closed won sales stage 207 to determine the average sales price 280, which is also displayed.

In one embodiment, the revenue funnel shows the records and events occurring at each stage of a user's marketing and sales process. The stages or levels of the funnel may be configured to match the user's business processes, including customizing the name and criteria for records that are included in each stage or level. The record count may display either the total number of records at that stage or level at a particular date or moment in time, or it may display the number of new records or events occurring within a predetermined range of time, such as last month, last quarter, last year, or a range from one selected date to a second selected date. The average sale price at the bottom of the funnel display reflects the average amount of each completed sale in the selected time period. The total revenue displays the total amount of completed sales in the time period. Additional data displayed on the screen includes but is not limited to marketing activities and sales activities related to the records at each stage or level of the funnel. The activity data may only show activities that occur related to a record or prospect at that level of the funnel. A legend indicates what portion of the records or events at each level or stage of the funnel are originated with marketing, with sales, with other business units, with channel partners, or with other sources.

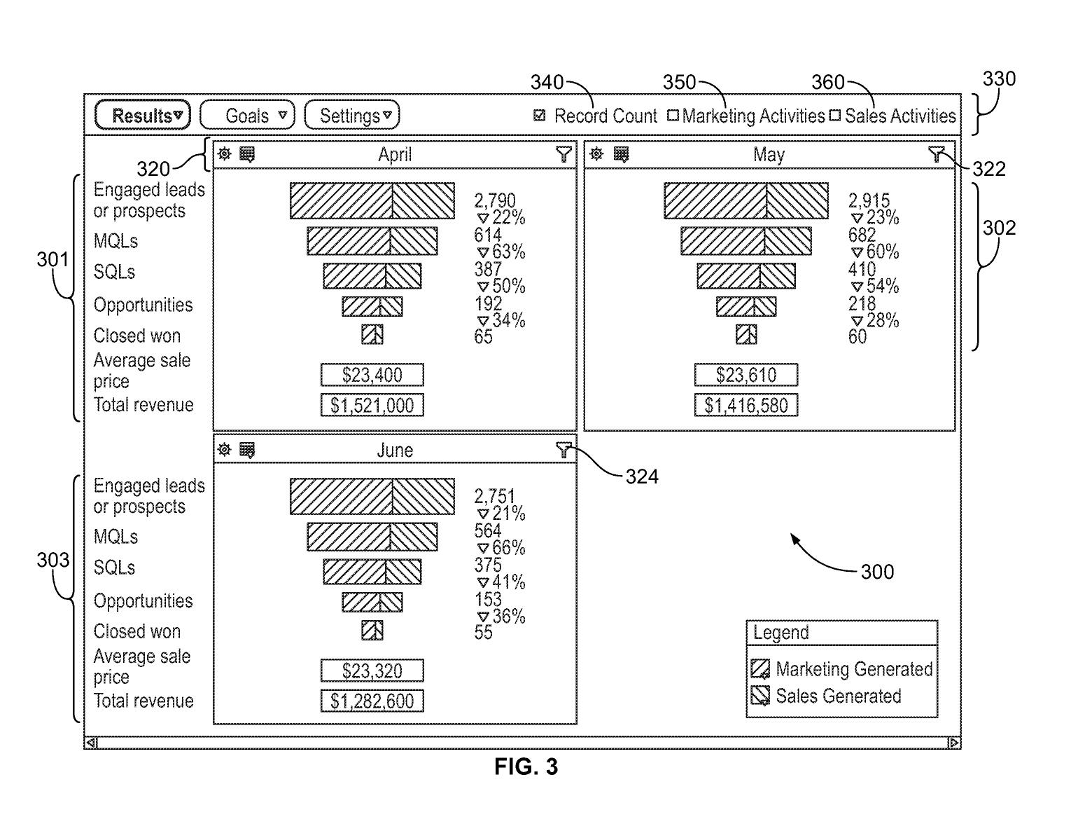

FIG. 3 illustrates an embodiment of a multi-time period MSASDS sales and marketing activity display interface 300. The multi-time period display interface 300 includes a first time period display 301, a second time period display 302, and a third time period display 303. A first time period selector 320 is associated with the first time period display 301, a second time period selector 322 is associated with the second time period display 302, and third time period selector is associated with the third time period display 303. Additionally, a display information configuration section 330 includes a Record count selector 340, a marketing activities selector 350, and a sales activities selector 360, activation of which allows the user to select and deselect for display the Record Count columns, the Marketing Activities Column, and/or the Sales Activities Column associated with the time period displays 301-303.

In operation, the MSASDS provides the user the option of entering a multi-time period display mode. When the multi-time period display mode is selected, the MSASDS queries the user to identify the number of time periods for display and then queries the user for the actual time period for each time period to display. Additionally, several default time periods are available for selection, such as displaying each of the last three months individually, as shown in FIG. 3.

Once the desired time period have been selected, the MSASDS forms the display for the indicated time period generally similarly to how the display interface 200 was determined as discussed above. More specifically, for each stage, the MSASDS retrieved electronic marketing and sales records for the database associated with the stage 122-128, determines the date associated with the customer record, and when the data associated with the customer record occurs within the desired time period, included the customer record in the count associated with that stage. The MSASDS then repeats the process for each of the three predetermined time periods shown in FIG. 3.

Similarly, the average sale price and total revenue are determined for each of the time periods as described above. Also, it is noted that in the embodiment of FIG. 3 only the record count selector 340 is activated. Consequently, only the record count column is displayed for each of the displays 301-303. The Vs. Previous Time Period column shown in FIG. 2 is not displayed, but may be displayed in an alternative embodiment.

Additionally, activation of the marketing activity selector 350 and sales activity selector 360 causes the marketing activity column and sales activity column to be displayed to the right of each of the displays 301-303 similarly to how the columns are displayed in FIG. 2.

In one embodiment, FIG. 3 illustrates a view of revenue funnels for multiple time periods compared to each other. The revenue funnels show the records and events occurring at each stage of a user's marketing and sales process. The stages or levels of each funnel may be configuring to match the user's business processes, including customizing the name and criteria for records that are included in each stage or level. The record count may display either the total number of records at that stage or level at a particular date or moment in time, or it may display the number of new records or events occurring within a predetermined range of time, such as last month, last quarter, last year, or a range from one selected date to a second selected date. The average sale price at the bottom of the funnel display reflects the average amount of each completed sale in the selected time period. The total revenue displays the total amount of completed sales in the time period. Additional data displayed on the screen includes but is not limited to marketing activities and sales activities related to the records at each stage or level of the funnel. The activity data preferably only shows activities that occur related to a record or prospect at that level of the funnel. A legend indicates what portion of the records or events at each level or stage of the funnel are originated with marketing, with sales, with other business units, with channel partners, or with other sources. A comparison is shown between the funnels for different time periods, for example, different months in the same calendar or fiscal quarter compared to each other. The comparison indicates the differences between months and whether the results for each level of stage of the funnel, and the conversion rates between stages, are trending up or down from one month to the next.

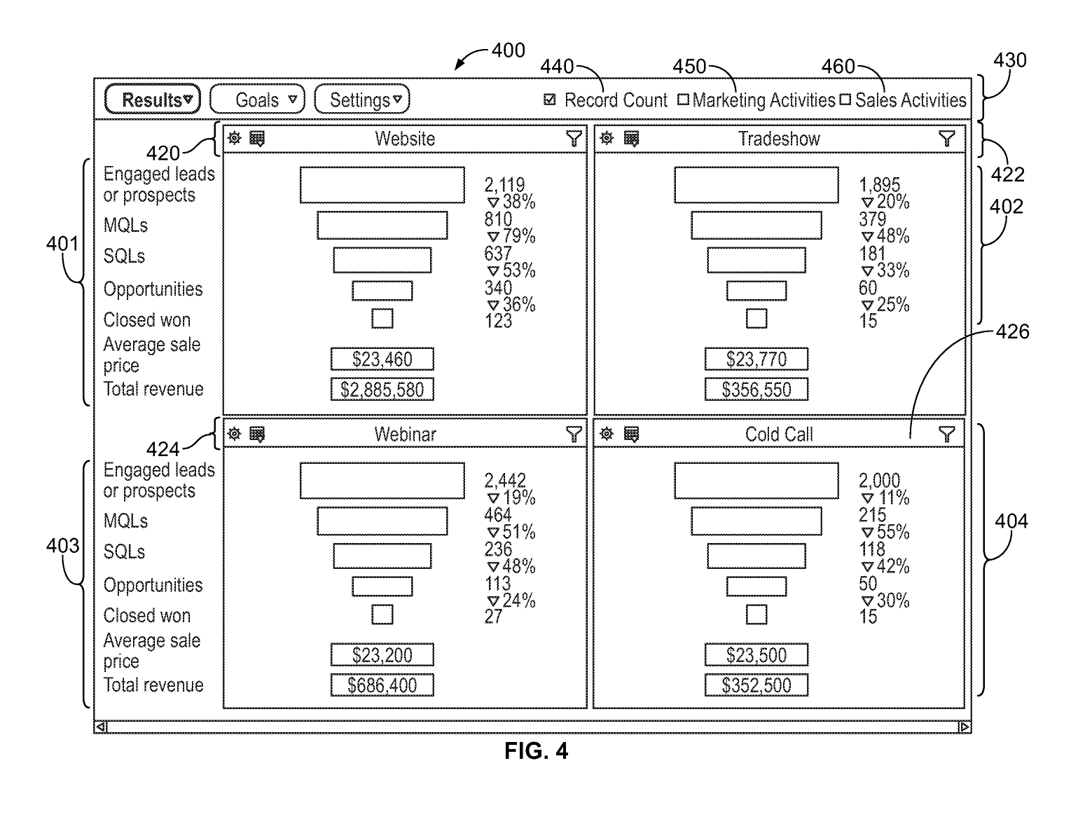

FIG. 4 illustrates an embodiment of a multi-activity MSASDS sales and marketing activity display interface 400 with a view of revenue funnels for different lead sources compared to each other. The multi-activity display interface 400 includes a website display 401, a tradeshow display 402, a webinar display 403, and a Cold Call display 404. Each of the displays 401-404 is associated with a display selector 420-426. Additionally, a display information configuration section 430 includes a Record Count selector 440, a marketing activities selector 450, and a sales activities selector 460, activation of which allows the user to select and deselect for display the Record Count columns, the Marketing Activities Column, and/or the Sales Activities Column associated with the time period displays 401-404.

In operation, the MSASDS provides the user the option of entering a multi-activity or record filter display mode. When the multi-activity display mode is selected, the MSASDS queries the user to identify the number of activities for display and then queries the user for the actual activities to display. The activities available for display include the predetermined activities included in the record filter database 130 that was previously populated by the MSASDS by reviewing electronic customer records. In one embodiment, the electronic customer record includes a field or identifier that the MSASDS has been pre-configured by the user to associate with a specific activity and/or lead source. For example, the electronic customer records may include a source identifier field. The source identifier field may be a textual description such as “internet” or “web” for which a user may configure the MSASDS to include in the “Website” activity or lead source. Alternatively, the identifier field may be a number, with certain numbers being pre-configured to be included in selected activity or lead source databases. Also, the MSASDS may be configured so that the existence of a field in the electronic record may cause the record to be classified as a certain activity or in a certain database. For example, if the electronic record includes a “Time of last webinar” field, then the electronic record may be classified as a “Webinar” activity.

Once the desired activities have been selected, the MSASDS forms the display for the indicated activities generally similarly to how the display interface 200 was determined as discussed above, but only using the electronic marketing and sales records associated with the specific activity, for example by inclusion in that activity's database.

More specifically, for the first stage of the Website activity, the MSASDS retrieves electronic customer records from a Website lead source database included in the record filter databases 130. The records are associated with this database based on the classification process previously described above.

The MSASDS then determines for each electronic marketing and sales record received from the Website lead source database whether it meets the criteria for inclusion in one or more of the stages, as generally described above with regard to FIG. 2. The MSASDS repeats the procedure for all of the stages for a specific activity. The MSASDS then repeats the procedure for each of the selected activities.

Similarly, the average sale price and total revenue are determined for each of the activities from the electronic customer records identified as being associated with the activity and identified as being included in the closed won stage. Also, it is noted that in the embodiment of FIG. 4 only the record count selector 440 is activated. Consequently, only the record count column is displayed for each of the displays 401-404. The Vs. Previous Time Period column shown in FIG. 2 is not displayed, but may be displayed in an alternative embodiment.

Additionally, activation of the marketing activity selector 450 and sales activity selector 460 causes the marketing activity column and sales activity column to be displayed to the right of each of the displays 401-404 similarly to how the columns are displayed in FIG. 2.

In one embodiment, FIG. 4 illustrates a view of revenue funnels for multiple different lead sources or marketing activities compared to each other. A lead source or marketing activity may be determined to match a user's specific marketing initiatives or methods by which they acquire and interact with prospective future customers or leads. The revenue funnels show the records and events occurring at each stage of a user's marketing and sales process. The stages or levels of each funnel may be configuring to match the user's business processes, including customizing the name and criteria for records that are included in each stage or level. The record count may display either the total number of records at that stage or level at a particular date or moment in time, or it may display the number of new records or events occurring within a predetermined range of time, such as last month, last quarter, last year, or a range from one selected date to a second selected date. The average sale price at the bottom of the funnel display reflects the average amount of each completed sale in the selected time period. The total revenue displays the total amount of completed sales in the time period. Additional data displayed on the screen includes but is not limited to marketing activities and sales activities related to the records at each stage or level of the funnel. The activity data only shows activities that occur related to a record or prospect at that level of the funnel. A legend indicates what portion of the records or events at each level or stage of the funnel are originated with marketing, with sales, with other business units, with channel partners, or with other sources. A comparison is shown between the funnels for different lead sources or marketing activities. The comparison indicates the differences between lead sources and whether the results for each level of stage of the funnel, and the conversion rates between stages, are trending up or down from one lead source to the next.

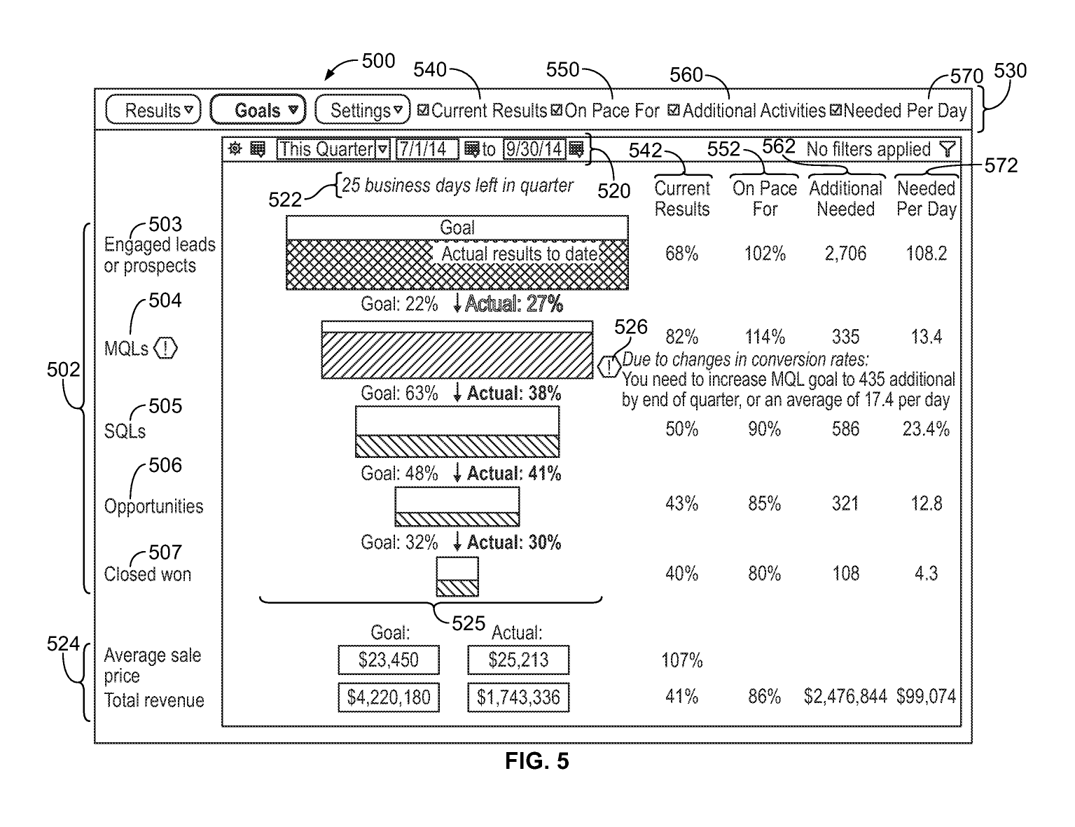

FIG. 5 illustrates an embodiment of the MSASDS sales and marketing activity and goal tracking interface 500. The goal tracking interface 200 includes a set of user-selected stages 502 for display including an Engaged Leads or Prospects stage 503, Marketing Qualified Leads (MQLs) stage 504, Sales Qualified Leads (SQLs) stage 505, Opportunities stage 506, and Closed Won Sales stage 507. The goal tracking interface 500 also includes a time period selector 520, and a display information configuration section 530. The display information configuration section 530 includes a Current Results selector 540, the On Pace For selector 550, the Additional Needed selector 560, and the Needed Per Day selector 565 to allow the user to select and deselect for display the respective columns 542, 552, 562, 572. Also shown are a remaining business day indicator 522, financial totals 524, and a shortfall alert 526.

In operation, a user such as a supervisor sets goals for a sales person or sales team for a predetermined time period such as a business quarter. The activity/conversion goals and associated sales person or team may be stored in the Goals Database 150. The actions of the sales person or team are then tracked at each stage and the current performance relative to the goals is displayable to the salesperson/team and/or supervisor. Additionally, any shortfalls from the goals are identified and an alert is displayed.

In operation, the supervisor may establish a salesperson name as a parameter and associated a database, such as the sales rep database 137 in which to store electronic marketing and sales records having a parameter matching the salesperson name. The MSASDS may then process all incoming electronic marketing and sales records and identify and store the records having a parameter matching the salesperson name in the sales rep database 137.

Later, when the goal tracking interface 500 is desired to be constructed, the MSASDS receives an indicator of the desired salesperson and retrieves the electronic customer records associated with the salesperson from the sales rep database 137 as further described below in FIG. 11.

The MSASDS then identifies which of the electronic marketing and sales records associated with the sales rep matches the predefined parameters for inclusion in each of the stages 503-507. Then, for each stage, the MSASDS determines the total number of records in the stage. The MSASDS then uses the indicator of the salesperson to identify and retrieve from the goals database 150 the activity goals for the salesperson that are associated with each stage. Next, the MSASDS compares the total number of records in each stage to the goal number of records in each stage.

Additionally, the MSASDS calculates the conversion rate between stages. For example, in one embodiment the conversion rate between the engaged leads or prospects stage 503 and the MQL stage 504 may have been previously set at a goal of 22%, which indicates that the number of MQLs should be at least 22% of the number of engaged leads or prospects.

Also, the MSASDS determines whether a sales person is on pace to meet their goals by dividing the activity goal for each stage by the number of days in the quarter and, for each incremental day in the quarter, adding one additional day's worth of activities to the goal for the stage. When the salesperson activities meet or exceed the goal for a stage, then the salesperson is considered to be on pace for the stage. When the salesperson activities are less than the goal for a stage, the salesperson is consider to not be on pace for the stage.

The results of the MSASDS calculations may be displayed in the graphical information 525. The graphic information includes a horizontal bar for each stage. The width of each horizontal bar is determined by the number of goal actions in each stage set by the supervisor. Between each bar appears the goal conversion rate selected by the supervisor as well as the actual calculated conversion rate. Additionally, each bar includes an internal graphical metric indicating the present percentage of completion of the goal by progressively vertically filling the bar with a graphical element such as a color. Thus, in one embodiment, as the percentage of records increases towards the goal, for a specific stage, the interior of the bar may begin to vertically fill with a color. Once the color fills the entire bar, the goal is met for that stage.

Additionally, the color that appears in the interior of the bar may be coded to represent whether the salesperson is on pace to meet their predetermined goals. For example, when the salesperson is on pace to meet their goals, the color inside the bar may be green and when the salesperson is not on pace to meet their goals the color inside the bar may be red.

When the Current Results indicator 540 is selected, the current results column 542 displays for each stage a percentage representing the number of records currently accomplished for each stage as compared to the goal number of record for each stage. Additionally, as mentioned above the MSASDS calculates whether the salesperson is on pace for each stage and may cause the interior color of the bar to be rendered in green or red if the salesperson is on pace or not on pace respectively.

Additionally, the current results column 540 may display an shortfall alert 526 directing the salesperson's attention to the process component that is most likely causing them to be off pace. For example, in FIG. 5, the conversion rate between the MQL stage 504 and the SQL stage 505 has a predetermined conversion goal of 63%, but the salesperson activity is only producing a conversion rate of 38%. Consequently, the shortfall alert 526 indicates that the conversion rate is below goal.

Additionally, the MSASDS calculates, assuming the actual conversion rate, a revised number of activities that the salesperson needs to perform based on the actual conversion rate in order to meet the goal. For example, as shown in FIG. 5, due to the actual conversion rate of 38% rather than the goal conversion rate of 63%, the salesperson must provide an additional 435 activities in the MQL stage in order to meet the goal number of activities for the SQL stage. Further, dividing the additional 435 activities by the remaining business days in the quarter 522, indicates that the salesperson must provide an additional 17.4 activities per day in order to remain on pace for the quarter. As shown in FIG. 5, the shortfall alert 526 preferably displays the reason for the shortfall, the number of additional actions needed in the stage, and the number of actions needed per day. In one embodiment, the shortfall alert appears at all stages that are below goal. In another embodiment, the shortfall alert only appears at the next stage above the highest stage in the funnel that is not meeting goal. If all of the stages in the funnel are not meeting goal, then the alert appears at the topmost stage.

Additionally, in one embodiment, the salesperson's conversion rate may be acceptable, but the record count in a specific stage may not be sufficient to meet the goal. In this case, the shortfall alert would identify the number of additional records that are required for the salesperson to get back on goal. The additional number of records needed may be calculated by subtracting the current number of records from the goal number. Additionally, the number of activities needed per day may be determined by dividing the additional number of records needed by the remaining days in the quarter.

When the On Pace For indicator 550 is selected, the On Pace For column 552 displays the percentage of goal that the salesperson is on pace for. In one embodiment, this is calculated by first setting a pace and then determining the salesperson's performance relative to the pace. In order to set the pace, the MSASDS divides the goal number of records for each stage by the number of business days per quarter to determine the number of records needed per day for each stage. The current day's pace is thus the number of business days in the quarter that have elapsed times the number of business records needed per day in the quarter for each stage. Next, the pace is compared to the actual number of records delivered by the salesperson and the result is displayed as a percentage for each stage.

When the Additional Needed indicator 560 is selected, the Additional Needed column 562 displays the remaining number of records needed for each stage in the current quarter. This may be calculated by subtracting the actual number of records delivered by the salesperson for each stage from the goal number of records for each stage. The result may then be displayed for each stage.

When the Needed Per Day indicator 570 is selected, the Needed Per Day column 572 displays the number of salesperson actions needed per day for the remaining quarter. The number of salespersons actions needed per day for the remaining quarter may be determined by dividing the remaining number of records needed for each stage in the current quarter (as determined above) by the number of remaining business days left in the quarter 522.

Additionally, the financial totals 524 include a goal sales price, an actual sales price, a goal total revenue, and an actual total revenue. The average sales price may be calculated by retrieving the sales price from each of the electronic customer records included in the closed won stage and averaging them. Additionally, the sum of all sales is the actual total revenue.

In the Current Results column 542 to the right of the financial totals 524 are shown a percentage of the actual sales price relative to the goal sales price and a percentage of the actual total revenue to the goal total revenue to date.

Additionally, in the On Pace For column 552 to the right of the financial totals 552 is shown a percentage representing the total revenue pace. The pace for total revenue may be determined by dividing the total revenue for the quarter by the number of business days per quarter to determine the total revenue needed per day. The current day's pace is thus the number of business days in the quarter that have elapsed times the total revenue needed per day in the quarter. Next, the pace is compared to the actual total revenue produced by the salesperson and the result is displayed as a percentage.

Also, in the Additional Needed column 562 to the right of the financial totals 524 is shown the additional needed total revenue to meet the predetermined goal. This may be determined by subtracting from the predetermined goal the actual total revenue to date and displaying the result.

Finally, in the Needed Per Day column 572 to the right of the financial totals 524 is shown the dollar amount representing the additional needed total revenue to meet the predetermined goal divided by the number of business days left in the quarter.

In one embodiment, FIG. 5 illustrates a view of a revenue funnel results vs. goals. The revenue funnel shows the records and events occurring at each stage of a user's marketing and sales process. The stages or levels of the funnel may be configured to match the user's business processes, including customizing the name and criteria for records that are included in each stage or level. The record count may display either the total number of records at that stage or level at a particular date or moment in time, or it may display the number of new records or events occurring within a predetermined range of time, such as last month, last quarter, last year, or a range from one selected date to a second selected date. The average sale price at the bottom of the funnel display reflects the average amount of each completed sale in the selected time period. The total revenue displays the total amount of completed sales in the time period. In this embodiment, the borders shown for each level of the funnel illustrate the overall goal that has been set for that metric, for example, the goal for the number of marketing qualified leads for the selected time period. The portion of graphic fill within the border indicates the progress towards the goal as of the selected date for reporting. The portion of graphic fill is relative to the portion of the overall goal that has been achieved, although the proportions may be adjusted to enhance the visual presentation of the funnel. The color coding of the fill illustrates whether the user or their respective team or business is ahead, behind, or on track for achieving the overall goal for metric by the end of the designated time period. For example, in one embodiment, results that are on pace to meet between 95% and 105% of goal may be shown in grey. Results that are on pace to exceed 105% may be shown in green. Results that are on pace to fall below 95% of goal may be shown in red. The specific colors and the thresholds for use of the colors may be adjusted by the user.

In one embodiment, the calculation for “pace” takes the total result as of the selected date and divided it by either the number of calendar days or business days that have been completed in the selected time period as of the designated date. The result is then multiplied by the total number of calendar days or business days in the total selected time period to determine what the possible end result at the end of the time period may be. In addition to this calculation, the system also displays the count of the number of additional leads or records needed to achieve the goal for the selected time period. An additional column takes the remaining count and divides it by the remaining number of calendar days or business days for the rest of selected time period in order to display an average number needed per day for the rest of the time period.

In one embodiment, the MSASDS also performs an additional calculation to evaluate whether the proper goals have been set at each level of the funnel to achieve the desire revenue goal for the time period. The calculation is performed by taking the goal amount of each level of the funnel, then multiplying it by the actual conversion percentages for each step lower in the funnel as seen over the time period to date and the by the average sale price as seen over the time period to date, and comparing the result to the revenue goal for the time period. If the result of the calculation is lower than the desired revenue goal, then the system calculates what amount the goal for the higher step in the funnel should be increased to in order to achieve the desired revenue goal if the conversion rates and average sale price lower in the funnel remain the same for the remainder of the time period. The difference between the higher calculated amount and the original goal for the step in the funnel is displayed to the user in the form of a notification. For example, in this embodiment, the system may alert the user, “Your marketing qualified lead goal should be increased from 335 to 435 to remain on track to achieve this quarter's revenue goal.”

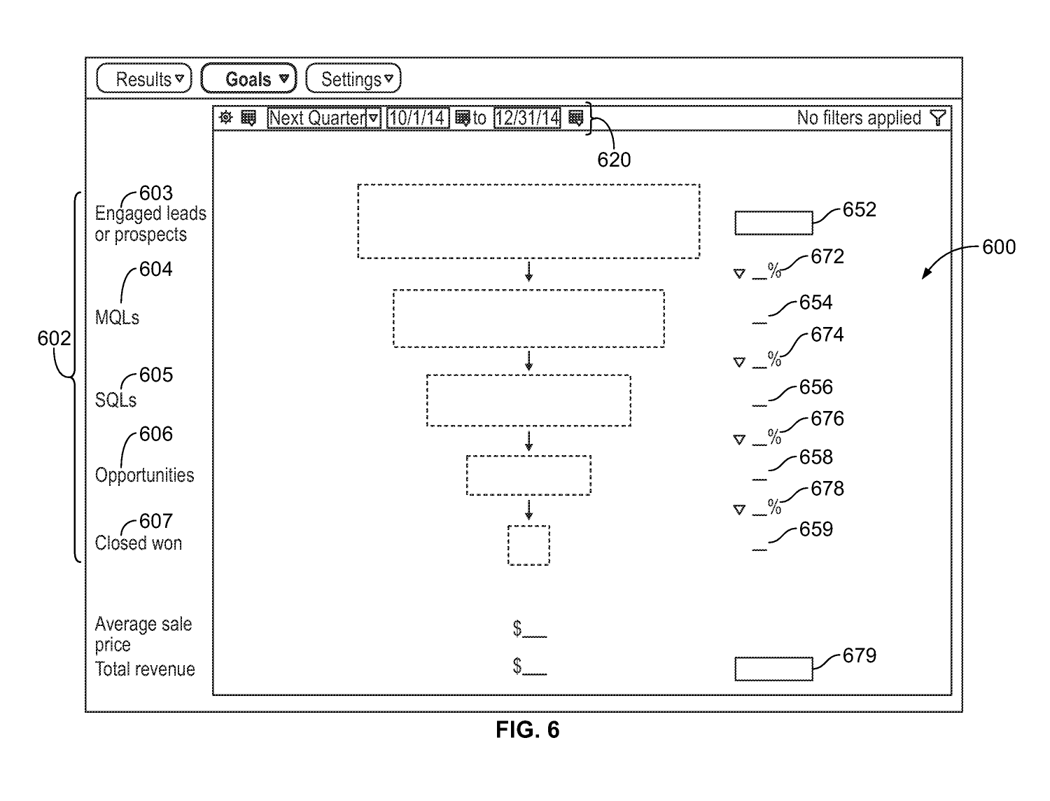

FIG. 6 illustrates an embodiment of a MSASDS sales and marketing activity goal determination interface 600. The goal determination interface includes a set of user-selected stages 602 including an Engaged Leads or Prospects stage 603, Marketing Qualified Leads (MQLs) stage 604, Sales Qualified Leads (SQLs) stage 605, Opportunities stage 606, and Closed Won Sales stage 607. The goal determination interface 600 also includes a time period selector 620.

The goal determination interface 600 allows a user such as a supervisor to set goals for number of records per stage and/or conversion rate and may provide real-time calculation of certain goals from selections made by the supervisor as described below. The results of the goal determination interface may then be stored in the goals database 150.

In operation, as shown below in FIG. 11, the user such as a supervisor first selects a salesperson or team for whom to set goals. Selection may be made from a drop-down list of available salespersons or teams. The supervisor may then select a specific date range for the goals by using the time period selector 620.

The supervisor may then enter goals in any of the stage goal quantities including the Engaged Leads or Prospects stage goal quantity 652, Marketing Qualified Leads (MQLs) stage goal quantity 654, Sales Qualified Leads (SQLs) stage goal quantity 656, Opportunities stage goal quantity 658, and Closed Won Sales stage goal quantity 659. Additionally, the supervisor may enter goals in any of the stage conversion rates including the Leads to MQL conversion rate 672, the MQL to SQL conversion rate 674, the SQL to Opportunities conversion rate 676, and the Opportunities to Closed Won conversion rate 678. Additionally, the supervisor may enter an average sales price and/or total revenue 679.

Thus, in one embodiment, FIG. 6 illustrates a process for setting goals for a future time period. Goals may be set for each level or stage of the revenue funnel, based on the goals for each of the metrics in the user's marketing and sales process. A blank revenue is displayed, and the user works through an interactive process to calculate goals with the system's assistance.

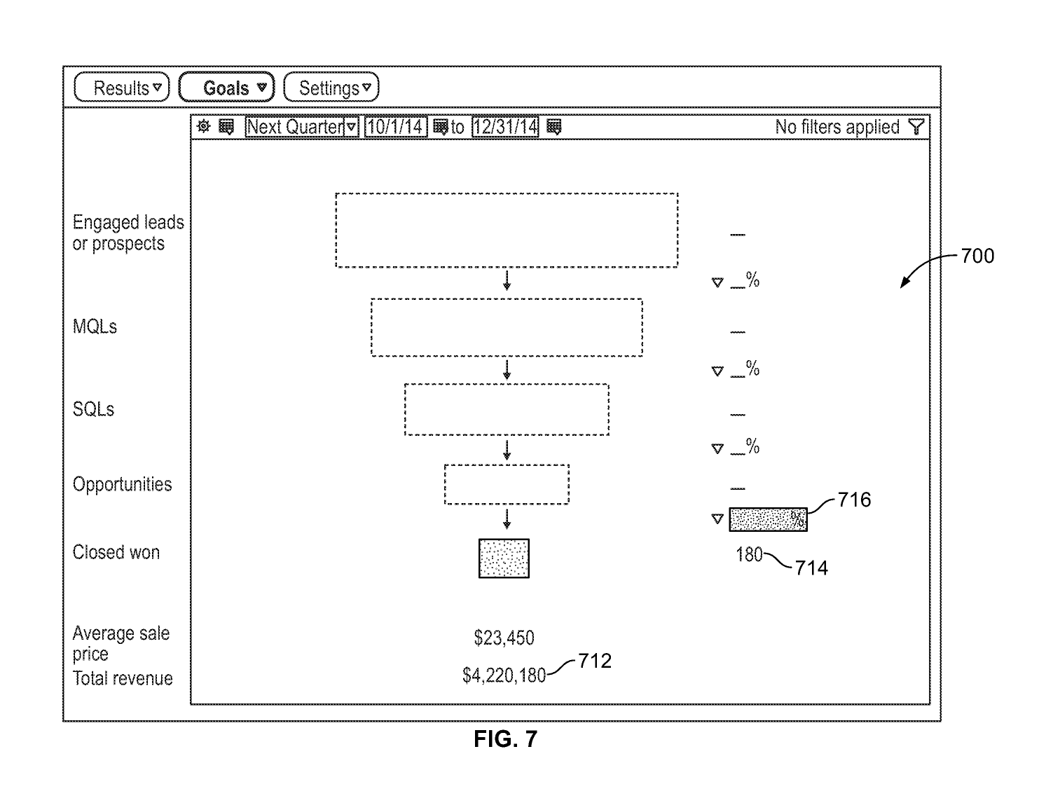

FIG. 7 illustrates one embodiment of the goal determination interface 700 wherein a supervisor builds backwards from a desired total revenue to set goals. In FIG. 7, the supervisor starts the goal process by assigning a total amount of revenue 712 that is desired for the salesperson over the current time period. The supervisor then enters a goal number of closed won activities. The MSASDS then calculates the average sale price by dividing the total revenue by the number of closed won activities and displays the average sale price in the goal determination interface.

The supervisor then enters a goal conversion rate 716 between the closed won stage and the opportunities stage. The MSASDS then uses the conversion rate to determine the number of activities forming the goal for the opportunities stage. For example, when 180 activities have been entered as a goal for the closed won stage and the supervisor enters a 50% conversion rate, the MSASDS calculates the goal number of activities for the Opportunities stage to be 360. The process may then proceed upward with the supervisor assigning a conversion rate at between each stage and the MSASDS calculating the goal number needed for the conversion rate. Once all of the goal numbers for each stage and goal conversion rates between stages have been determined, the goal numbers and rates are then stored in the goals database for that salesperson.

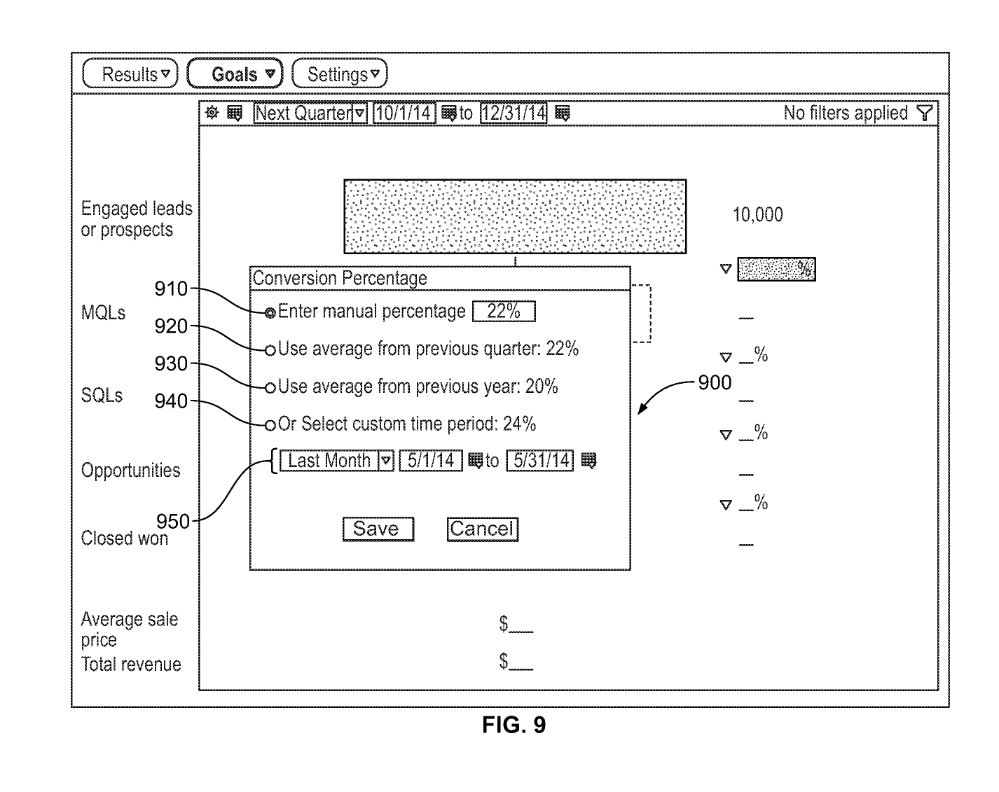

In one embodiment, FIG. 7 illustrates an example of the user entering a total revenue goal for a future time period. After entering the revenue goal, the user then works backwards up the funnel, setting a goal for the average sale price and the conversion rate from each step in the funnel to the next. The system suggests recommended values for the average sale price and each conversion rate based on analysis of historical time periods as shown below in FIG. 9. As the user confirms the desired number to use for each conversion rate, the system calculates the value to set for each goal by dividing the value of previous by the selected conversion rate up to the next step in the funnel.

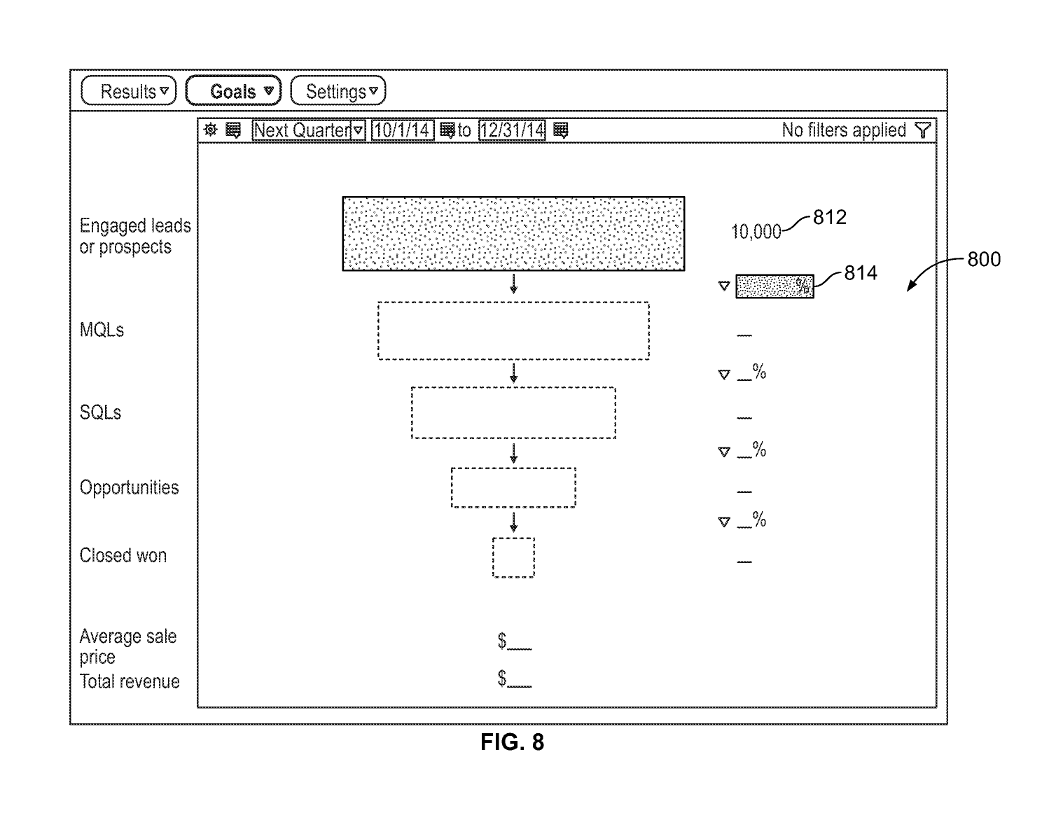

FIG. 8 illustrates another embodiment of the goal determination interface 600 wherein a supervisor builds forward from a desired number of leads to set goals. In FIG. 8, the supervisor selects a sales person and a time period for goal setting, as described in FIG. 7 above. Next, the supervisor enters a number of leads 812 that may be assigned to the salesperson for the current time period. Next, the supervisor enters a conversion rate for passing from the Engaged Leads stage to the MQL stage. The MSASDS then uses the conversion rate to determine the number of activities in the MQL stage to set as a goal. For example, when the number of leads is 10,000, the conversion rate from leads to MQL may be set at 50% by the supervisor. Thus, the number of activities that is set as a goal for the MQL stage would be 5,000. The supervisor may then continue setting the conversion rate between stages to set the goal number of activities for each stage. The supervisor then enters an average sale price. The MSASDS multiplies the calculated closed won sales by the average sale price to determine the total revenue.

In one embodiment, FIG. 8 illustrates an example of the goal setting process functioning in reverse, with the user starting by entering a value for the top level of the funnel, for example marketing leads. After entering the top goal, the user then works down the funnel, setting a goal for the conversion from each step in the funnel to the next and a goal for the average sale price. The system suggests recommended values for each conversion rate and the average sale price based on analysis of historical time periods as shown below in FIG. 9. As the user confirms the desired number to use for each conversion rate, the system calculates the value to set for each by multiplying the value of the previous goal at the higher step in the funnel by the selected conversion rate.

FIG. 9 illustrates a conversion percentage adjustment interface 900. As described above with regard to FIG. 8, the conversion percentage adjustment interface 900 provides several recommended values for each conversion rate and the average sale price based on analysis of historical time periods. As shown in FIG. 9, the conversion percentage adjustment interface 900 includes a manual conversion rate election 910, a previous quarter average selection 920, a previous year average selection 930, and a custom time period selection 940 including a time period selection 950.

In an alternative embodiment, a group or team average including multiple participants may be displayed for reference and potential inclusion as a conversion percentage. Additionally, a team goal may be displayed, for example 10% above team performance for a specified time period.

Once the conversion percentage is selected using the conversion percentage adjustment interface 900, the selected conversion percentage is entered in the underling interface, such as that shown in FIG. 8. Additionally, the conversion percentage is used to calculate the goal or target for the next stage, as described above with regard to FIG. 8.

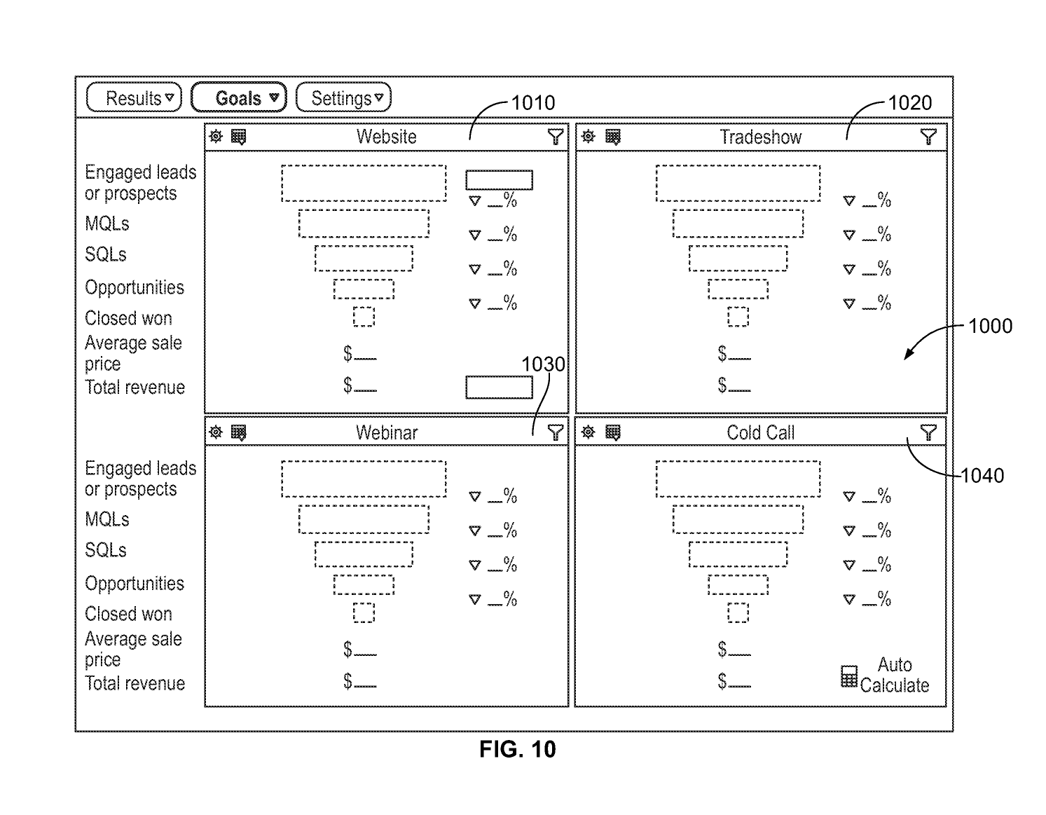

FIG. 10 illustrates an embodiment of a lead source activity goal determination interface 1000. The lead source activity goal determination interface 100 operates generally similar to the MSASDS sales and marketing activity goal determination interface 600 described in FIG. 6, but allows the supervisor to set goals for lead sources individually selected by the supervisor. The example lead source activity goal determination interface 1000 includes a “Website” activity goal determination interface 1010, a “Tradeshow” activity goal determination interface 1020, a “Webinar” activity goal determination interface 1030, and a “Cold Call” activity goal determination interface 1040. Further, additional or alternative lead sources may be established by the user or supervisor as described herein.

Thus, in one example or operation, a supervisor may enter 1000 for the “Website” lead source, and enter conversion percentages, average sale price, and total revenue to populate the Website activity goal determination interface 1010. The supervisor may then enter 250 for the “Webinar” lead source and enter different conversion percentages, average sale price, and total revenue to populate the Webinar activity goal determination interface 1030. The other interfaces may be populated in a similar fashion.

Further, in one embodiment, the performance of each interface relative to the configured goal may be tracked separately. For example, the number of MQLs in the Website interface may meet the configured goal, but the number of MQLs in the Cold Call interface may not. Thus, when any goal in any interface is not met, a shortfall alert may be displayed proximal to the goal, as shown in FIG. 5.

The lead source goals shown in FIG. 10 may be established instead of the overall goals shown in FIGS. 6-9 or in addition to the overall goals. Further, the conversion percentage adjustment interface 900 of FIG. 9 may be used to enter the conversion percentages for any of the lead sources shown in FIG. 10. Additionally, the conversion percentage adjustment interface may include both the overall conversion percentages and the lead source specific conversion percentages for inclusion.

Additionally, in one embodiment, when individual lead source goals have been selected, but the user is viewing the overall tracking screen as shown in FIG. 5, the shortfall alert may include a display of the lead source goal that is not being met. For example, when an overall conversion percentage from MQL to SQL is being met, but a pre-configured conversion percentage for Webinar MQL to SQL is not being met, the overall goal tracking interface of FIG. 5 may include a shortfall alert confirming that while the overall conversion is met, the conversion for the Webinar lead source is not being met, as well as the lead source specific needed additional activity to meet the lead source goal. This may be determined as generally described above with regard to the overall conversion activity for those stages, but applying only to activities classified as a Webinar lead source.

FIG. 11 illustrates a sample supervisor or control screen 1100 for configuring and the activity display interfaces shown in FIGS. 1-10. The control screen 1100 includes a results selector 1110, a goals selector 1120, a participant listing 1130, and a participant selector 1130. In operation, as generally described above, a supervisor may select the results selector 1110 and one or more of the participants using the participant selector 1130. When more than one participant is selected, the control screen 1100 queries whether results should be displayed as an aggregate of all participants (for example, as a sales team) or in individual displays. Additional queries allow the user to select an individual time period for display (as shown in FIG. 3) or select a lead source (as shown in FIG. 4).

Alternatively, in operation, as generally described above, a supervisor may select the goal selector 1120 and one or more of the participants using the participant selector 1130. Similarly, when more than one participant is selected, the control screen 1100 queries whether results should be displayed as an aggregate of all participants (for example, as a sales team) or in individual displays. Additional queries allow the selection of a time period and allow the display to enter either a goal tracking display as shown in FIG. 5, or one of the goal setting interfaces shown in FIGS. 6-10. Further, when the lead source goal setting interface of FIG. 10 is selected, the system further queries for the specific lead sources to include in the display. For example, the lead sources to include in the display may be selected from a drop down menu.

Referring now back to the operation of the MSASDS described in FIG. 1, in the embodiment of FIG. 1, once the user has defined the number of stages or databases 120 and configured the identifiers and/or parameters for selecting an electronic record for inclusion in one or more of the stages or databases 120, the MSASDS 110 retrieves, sorts, and stores the electronic records in their respective databases.

However, in an alternative embodiment, the MSASDS need not retrieve and store the electronic records, instead, external system 170 may be queried by the real-time external data query system 119 of FIG. 1 using the stages and parameters that have been previously defined and the results may be displayed by the MSASDS, for example in the sales and marketing activity display interface 200 of FIG. 2. Such an alternative may have an advantage of requiring less storage space, but may be more computationally intensive.

As an additional alternative, instead of storing the entire electronic record itself, the MSASDS may store an electronic pointer to the electronic record on the external system. In this embodiment, the electronic records may be received from the external system 170 and processed by the MSASDS to identify which records to include in the individual stages and then a pointer or other indicator of the electronic record may be stored in the databases 120 instead of the entire electronic record itself.

As an additional alternative, instead of storing the entire electronic record, the MSASDS may only store the portion of the electronic record that represents parameters that have been selected by the user for use in classifying the electronic record as belonging in one or more stages. For example, when the electronic record includes 10 parameters, but only 5 of the parameters are used in determining which of five stages and/or databases to classify the electronic record, the stored electronic record may be truncated to only include the information representing the 5 parameters used in the determination.

While particular elements, embodiments, and applications of the present invention have been shown and described, it is understood that the invention is not limited thereto because modifications may be made by those skilled in the art, particularly in light of the foregoing teaching. It is therefore contemplated by the appended claims to cover such modifications and incorporate those features which come within the spirit and scope of the invention.

1. A computerized sales and marketing process management system, said system including:
a marketing activity and status display system, said marketing activity and status display system receiving a plurality of stage identifiers from a user and storing said plurality of stage identifiers, wherein each of said plurality of stage identifiers is associated with an individual stage,
wherein said marketing activity and status display system also receives and stores a plurality of sets of stage identification parameters, wherein each of said plurality of stage identifiers is associated with one of said plurality of sets of stage identification parameters;
a plurality of databases, wherein each of said plurality of databases is associated with one of said stage identifiers;
a marketing and sales record characterization system, said marketing and sales record characterization system receiving a plurality of electronic records from an external system, each of said plurality of electronic records including a plurality of electronic record parameters,
wherein said marketing and sales record characterization system receives said plurality of sets of stage identification parameters, compares them to said electronic record parameters, and when said electronic record parameters match one of said plurality of sets of stage identification parameters, associates said electronic record with the stage identifier associated with said set of stage identification parameters and stores said electronic record in said database associated with said stage identifier; and
a goal tracking system, said goal tracking system receiving a plurality of goals, wherein a stage conversion ratio is the difference between the total number of electronic records included in a first stage and the total number of electronic records included in a subsequent stage, wherein each of said plurality goals is one of a goal stage conversion ratio between one of said stages identified by said stage identifiers and a goal electronic record number for one of said stages identified by said stage identifiers,
wherein said goal tracking system uses said plurality of goals to determine a goal electronic record number for each stage and a goal conversion ratio between each of said plurality of stages,
wherein said goal tracking system retrieves said electronic records from said plurality of databases and determines an actual electronic record number for each stage and an actual goal conversion ratio between each of said plurality of stages,
wherein said goal tracking system displays a shortfall alert when at least one of said actual electronic record number for a stage is less than said goal electronic record number for said stage or when said actual conversion ratio between two stages is less than said goal conversion ratio between said stages,
wherein said shortfall alert includes an indication of the at least one actual record number or actual conversion ratio that is less than its respective goal.

2. The system of claim 1 wherein, when said goal tracking system displays a shortfall alert, said goal tracking system calculates and displays a shortfall difference representing the difference between said actual electronic record number or actual conversion ratio and its respective goal.

3. The system of claim 2 wherein an indication of the end of the current evaluation period has been received by said goal tracking system and, when said goal tracking system displays a shortfall alert, said goal tracking system divides said shortfall difference by the number of business days until said end of the current evaluation period and displays the result as a number of additional electronic records needed in that stage on average until the end of the current evaluation period.

4. The system of claim 1 wherein, when said goal tracking system displays a shortfall alert, said alert identifies and displays an indication that an increase in conversion rate is desired for a stage when a previous stage meets its goal electronic record number, but its immediate subsequent stage does not meet its goal electronic record number.

5. The system of claim 1 further including:
a marketing electronic record database; and
a sales electronic record database,
wherein said marketing activity and status display system receives and stores a set of marketing activity identification parameters and a set of sales activity identification parameters,
wherein said marketing and sales record characterization system compares said set of marketing activity identification parameters and said set of sales activity identification parameters to said electronic record parameters, and when said electronic record parameters match said set of marketing activity parameters, stores said electronic record in said marketing database, and when said electronic record parameters match said set of sales activity parameters, stores said electronic record in said sales database.

6. The system of claim 1 further including:
a plurality of record filter databases
wherein said marketing activity and status display system receives and stores a plurality of sets of record filter identification parameters, wherein each of said plurality of sets of record filter identification parameters is associated with one of said plurality of record filter databases,
wherein said marketing and sales record characterization system compares said plurality of sets of record filter identification parameters to said electronic record parameters, and when said electronic record parameters match one of said plurality of sets of record filter identification parameters, stores said electronic record in said record filter database associated with said set of record filter identification parameters.

7. The system of claim 1 wherein said electronic records are associated with at least one person and said plurality of goals represents a goal for electronic records associated or conversion rate associated with a single person.

8. The system of claim 1 wherein said electronic records are associated with at least one person and said plurality of goals represent goals for the total number electronic records or conversion rate for electronic records associated with multiple people.

9. A method for computerized sales and marketing process management, said method including:
receiving a plurality of stage identifiers from a user at a marketing activity and status display system;
storing said plurality of stage identifiers, wherein each of said plurality of stage identifiers is associated with an individual stage;
receiving and storing a plurality of sets of stage identification parameters, wherein each of said plurality of stage identifiers is associated with one of said plurality of sets of stage identification parameters;
associating a plurality of databases with said stage identifiers, wherein each of said plurality of databases is associated with one of said stage identifiers;
receiving, at a marketing and sales record characterization system, a plurality of electronic records from an external system, each of said plurality of electronic records including a plurality of electronic record parameters;
receiving, at said marketing and sales record characterization system, said plurality of sets of stage identification parameters;
comparing said plurality of sets of stage identification parameters to said electronic record parameters, and when said electronic record parameters match one of said plurality of sets of stage identification parameters, associating said electronic record with the stage identifier associated with said set of stage identification parameters and storing said electronic record in said database associated with said stage identifier;
determining a stage conversion ratio as the difference between the total number of electronic records included in a first stage and the total number of electronic records included in a subsequent stage;
receiving, at a goal tracking system, a plurality of goals wherein each of said plurality goals is one of a goal stage conversion ratio between one of said stages identified by said stage identifiers and a goal electronic record number for one of said stages identified by said stage identifiers;
determining, using said plurality of goals, a goal electronic record number for each stage and a goal conversion ratio between each of said plurality of stages;
retrieving, using said goal tracking system, said electronic records from said plurality of databases,
determining an actual electronic record number for each stage and an actual goal conversion ratio between each of said plurality of stages; and
displaying a shortfall alert when at least one of said actual electronic record number for a stage is less than said goal electronic record number for said stage or when said actual conversion ratio between two stages is less than said goal conversion ratio between said stages,
wherein said shortfall alert includes an indication of the at least one actual record number or actual conversion ratio that is less than its respective goal.

10. The method of claim 9 wherein, when displaying a shortfall alert, additionally calculating and displaying a shortfall difference representing the difference between said actual electronic record number or actual conversion ratio and its respective goal.

11. The method of claim 10 wherein an indication of the end of the current evaluation period has been received by said goal tracking system and, when displaying a shortfall alert,
dividing said shortfall difference by the number of business days until said end of the current evaluation period; and
displaying the result as a number of additional electronic records needed in that stage on average until the end of the current evaluation period.

12. The method of claim 9 wherein, when displaying a shortfall alert, said alert identifies and displays an indication that an increase in conversion rate is desired for a stage when a previous stage meets its goal electronic record number, but its immediate subsequent stage does not meet its goal electronic record number.

13. The method of claim 9 further including:
receiving and storing, at said marketing activity and status display system, a set of marketing activity identification parameters and a set of sales activity identification parameters,
comparing, using said marketing and sales record characterization system, said set of marketing activity identification parameters and said set of sales activity identification parameters to said electronic record parameters;
when said electronic record parameters match said set of marketing activity parameters, storing said electronic record in a marketing database; and
when said electronic record parameters match said set of sales activity parameters, storing said electronic record in a sales database.

14. The method of claim 9 further including:
receiving and storing, at said marketing activity and status display system, a plurality of sets of record filter identification parameters, wherein each of said plurality of sets of record filter identification parameters is associated with one of said plurality of record filter databases;
comparing said plurality of sets of record filter identification parameters to said electronic record parameters; and
when said electronic record parameters match one of said plurality of sets of record filter identification parameters, storing said electronic record in said record filter database associated with said set of record filter identification parameters.

15. The method of claim 9 wherein said electronic records are associated with at least one person and said plurality of goals represents a goal for electronic records associated or conversion rate associated with a single person.

16. The method of claim 9 wherein said electronic records are associated with at least one person and said plurality of goals represent goals for the total number electronic records or conversion rate for electronic records associated with multiple people.

17. A system for establishing marketing and sales goals and tracking performance, said system including:
a marketing activity and status display system, said marketing activity and status display system receiving a plurality of stage identifiers from a user and storing said plurality of stage identifiers, wherein each of said plurality of stage identifiers is associated with an individual stage,
wherein said marketing activity and status display system also receives and stores a plurality of sets of stage identification parameters, wherein each of said plurality of stage identifiers is associated with one of said plurality of sets of stage identification parameters;
a plurality of databases, wherein each of said plurality of databases is associated with one of said stage identifiers;
a goals determination system, wherein said goals determination system receives for each of said stages either a goal electronic record number or a goal stage conversion ratio, wherein a stage conversion ratio is the difference between the total number of electronic records included in a first stage and the total number of electronic records included in a subsequent stage, wherein said goals determination system uses said goal electronic record numbers of goal stage conversion ratios to determine both a goal electronic record number for each stage and a goal stage conversion ratio for each stage;
a marketing and sales record characterization system, said marketing and sales record characterization system receiving a plurality of electronic records from an external system, each of said plurality of electronic records including a plurality of electronic record parameters,
wherein said marketing and sales record characterization system receives said plurality of sets of stage identification parameters, compares them to said electronic record parameters, and when said electronic record parameters match one of said plurality of sets of stage identification parameters, associates said electronic record with the stage identifier associated with said set of stage identification parameters and stores said electronic record in said database associated with said stage identifier; and
a goal tracking system, wherein said goal tracking system retrieves said electronic records from said plurality of databases and determines an actual electronic record number for each stage and an actual goal conversion ratio between each of said plurality of stages,
wherein said goal tracking system displays a shortfall alert when at least one of said actual electronic record number for a stage is less than said goal electronic record number for said stage or when said actual conversion ratio between two stages is less than said goal conversion ratio between said stages,
wherein said shortfall alert includes an indication of the at least one actual record number or actual conversion ratio that is less than its respective goal.

18. The system of claim 17 wherein said goals determination system allows a user to select a goal stage conversion ratio from one of: a manually selected percentage, an actual goal stage conversion ratio determined by said goals determination system from a previous predetermined time period, and an actual goal stage conversion ratio determined by said goals determination system from a user-selected previous time period.

19. The system of claim 17 wherein said electronic records are associated with at least one person and said goal electronic record number for each stage and goal stage conversion ratio represent a goal for electronic records associated or conversion rate associated with a single person.

20. The system of claim 17 wherein said electronic records are associated with at least one person and said goal electronic record number for each stage and a goal stage conversion ratio represent goals for the total number electronic records or conversion rate for electronic records associated with multiple people.
